(19) United States
(12) Patent Application Publication
(10) Pub. No.: US 2021/0136250 A1
(43) Pub. Date: May 6, 2021

(54) INFORMATION PROCESSING SYSTEM

(71) Applicant: KYOCERA Document Solutions Inc., Osaka-shi (JP)

(72) Inventor: Hisakazu NISHIYAMA, Osaka-shi (JP)

(21) Appl. No.: 17/079,593

(22) Filed: Oct. 26, 2020

(30) Foreign Application Priority Data
Oct. 31, 2019 (JP) 2019-198262

(51) Int. Cl. H04N 1/32; H04N 1/327; G06F 3/12

(52) U.S. Cl. CPC H04N 1/32368; H04N 1/32793; G06F 3/1225; G06F 3/1236; G06F 3/1203

(57) ABSTRACT

A kiosk terminal includes a function enhancement application and an I/F application that cooperate with each other, and an I/F application updater for updating the I/F application. The I/F application includes an I/F application service that, in a case where a call is made from the function enhancement application to the I/F application, executes processing according to the call, and an I/F application DLL that notifies the function enhancement application of the execution result of the processing by the I/F application service. The function enhancement application reads the I/F application DLL rather than the I/F application service. The I/F application updater updates the I/F application service.

### INCORPORATION BY REFERENCE

This application is based upon, and claims the benefit of priority from, corresponding Japanese Patent Application No. 2019-198262 filed in the Japan Patent Office on Oct. 31, 2019, the entire contents of which are incorporated herein by reference.

### BACKGROUND

### Field of the Invention

The present disclosure relates to an information processing system that realizes two applications that cooperate with each other.

### Description of Related Art

Conventionally, an information processing system is known that realizes two applications that cooperate with each other. However, in the conventional information processing system, it only becomes possible to update one of the two applications cooperating with each other when the other application is stopped. That is to say, when one of the two applications cooperating with each other is updated, it is necessary to stop the other application.

### SUMMARY

An information processing system of the present disclosure includes: a first application and a second application that cooperate with each other; and an update application for updating the second application; wherein the second application includes a main body portion that, in a case where a call is made from the first application to the second application, executes processing according to the call, and an interface portion that notifies the first application of an execution result of the processing, the first application reads the interface portion rather than the main body portion, and the update application updates the main body portion.

In the information processing system of the present disclosure, the main body portion may, in a case where the call is made while being updated by the update application, execute the processing after an update has been performed by the update application.

In the information processing system of the present disclosure, the update application may, in a case where an update of the main body portion has failed, perform a rollback of the main body portion to a state of the main body portion prior to an update operation, and the main body portion may, in a case where the call is made while being updated by the update application, and an update by the update application fails, execute the processing after a rollback is performed by the update application.

### BRIEF DESCRIPTION OF THE DRAWINGS

FIG. 1 is a block diagram of an image forming system according to an embodiment of the present disclosure;

FIG. 2 is a block diagram of the image forming device shown in FIG. 1;

FIG. 3 is a block diagram of the kiosk terminal shown in FIG. 1;

FIG. 4 is a sequence diagram of the operation performed by the kiosk terminal shown in FIG. 3 when a function enhancement application is started;

FIG. 5 is a sequence diagram of the operation performed by the kiosk terminal shown in FIG. 3 when an I/F application DLL receives an API call from the function enhancement application;

FIG. 6 is a sequence diagram of the “normal processing” shown in FIG. 5;

FIG. 7 is a sequence diagram of the “process execution” shown in FIG. 6;

FIG. 8 is a sequence diagram of the operation performed by the kiosk terminal shown in FIG. 3 when an I/F application service is updated;

FIG. 9 is a sequence diagram of the “update” shown in FIG. 8;

FIG. 10 is a sequence diagram of the operation performed by the kiosk terminal shown in FIG. 3 when an I/F application service is updated but installation of a new I/F application service fails; and

FIG. 11 is a sequence diagram of the operation performed by the kiosk terminal shown in FIG. 3 when an I/F application service is updated but uninstallation of an old I/F application service fails.

### DETAILED DESCRIPTION

Hereinafter, an embodiment of the present disclosure will be described using the drawings.

First, the configuration of an image forming system according to an embodiment of the present disclosure will be described.

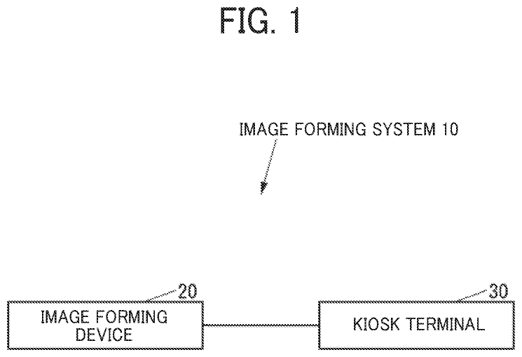

FIG. 1 is a block diagram of an image forming system 10 according to the present embodiment.

As shown in FIG. 1, the image forming system 10 includes an image forming device 20 such as an MFP (Multifunction Peripheral), and a kiosk terminal 30 serving as an information processing system that cooperatively operates with the image forming device 20 to enhance the functions of the image forming device 20. The image forming system 10 is placed, for example, in a retail store such as a convenience store.

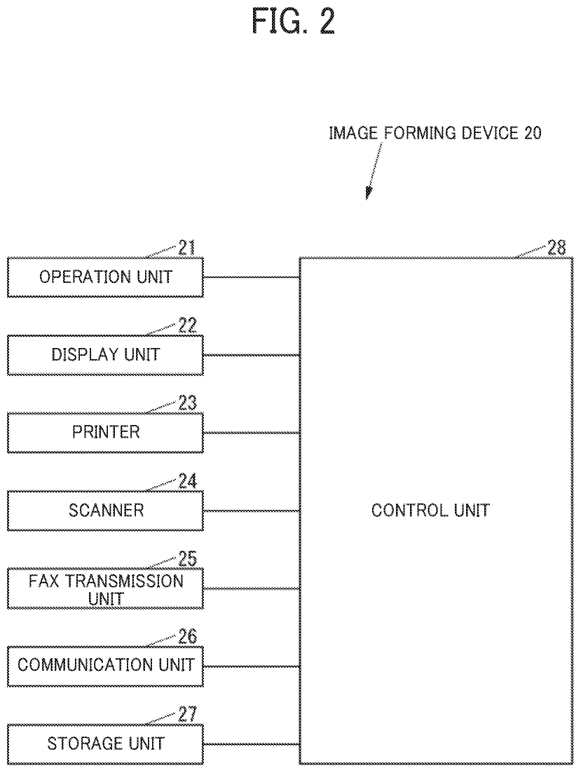

FIG. 2 is a block diagram of the image forming device 20.

As shown in FIG. 2, the image forming device 20 includes: an operation unit 21, which is an operation device to which various operations are input, such as buttons; a display unit 22, which is a display device such as an LCD (Liquid Crystal Display) that displays various information; a printer 23, which is a printing device that prints images on a recording medium such as paper; a scanner 24, which is a reading device that reads images from a document; a fax communication unit 25, which is a fax device that performs fax communication with an external facsimile device (not shown) via a communication line such as a public telephone line; a communication unit 26, which is a communication device that communicates with an external device via a network such as a LAN (Local Area Network) or the Internet, or directly in a wired or wireless fashion without going through a network; a storage unit 27, which is a non-volatile storage device such as a semiconductor memory or an HDD (Hard Disk Drive) that stores various information; and a control unit 28 that controls the image forming device 20 as a whole.

The control unit 28 includes, for example, a CPU (Central Processing Unit), a ROM (Read Only Memory) that stores programs and various data, and a RAM (Random Access Memory) serving as the memory used as a work area of the CPU of the control unit 28. The CPU of the control unit 28 executes programs stored in the storage unit 27 or the ROM of the control unit 28.

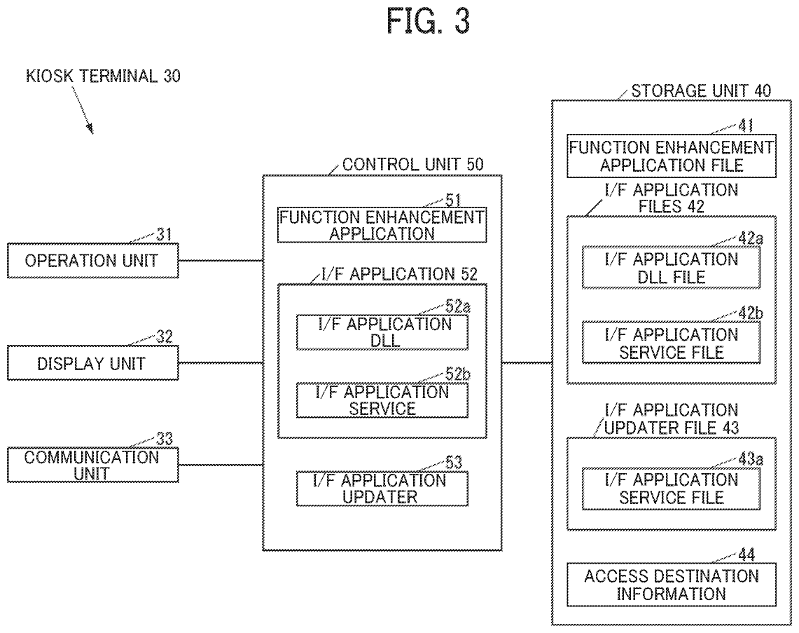

FIG. 3 is a block diagram of the kiosk terminal 30.

As shown in FIG. 3, the kiosk terminal 30 includes: an operation unit 31, which is an operation device to which various operations are input, such as buttons; a display unit 32, which is a display device such as an LCD that displays various information; a communication unit 33, which is a communication device that communicates with an external device via a network such as a LAN or the Internet, or directly in a wired or wireless fashion without going through a network; a storage unit 40, which is a non-volatile storage device such as a semiconductor memory or an HDD that stores various information; and a control unit 50 that controls the kiosk terminal 30 as a whole.

The storage unit 40 stores a function enhancement application file 41, which is a file of a function enhancement application serving as a first application for enhancing the functions of the image forming device 20. The function enhancement application file 41 is an application that, for example, acquires data from a device that is external to the image forming system 10 via the Internet, and executes printing on the image forming device 20 based on the acquired data. Examples of such an application include: an application that acquires residency certificate data via the Internet from a server which manages residency certificate data, which is a device that is external to the image forming system 10, and causes the image forming device 20 to print a residency certificate based on the acquired data; and an application that acquires musical score data via the Internet from a server that manages musical score data, which is a device that is external to the image forming system 10, and causes the image forming device 20 to print a musical score based on the acquired data. The function enhancement application file 41, for example, may be installed on the kiosk terminal 30 at the manufacturing stage of the kiosk terminal 30, may be additionally installed on the kiosk terminal 30 from an external recording medium such as a USB (Universal Serial Bus) memory, or may be additionally installed on the kiosk terminal 30 from a network.

The storage unit 40 stores an I/F application file 42, which is a file of an I/F (interface) application serving as a second application for communicating with a device that is external to the image forming system 10. The I/F application is an application which is assumed to be used from the function enhancement application. The I/F application file 42 includes an I/F application DLL file 42a, which is a file of an I/F application DLL serving as an interface portion configured by a DLL (Dynamic Link Library) that is responsible for the interface function of the I/F application, and an I/F application service file 42b, which is a file of an I/F application service serving as a main body portion configured by an EXE file that is responsible for the logic body of the I/F application. The I/F application file 42, for example, may be installed on the kiosk terminal 30 at the manufacturing stage of the kiosk terminal 30, may be additionally installed on the kiosk terminal 30 from an external recording medium such as a USB memory, or may be additionally installed on the kiosk terminal 30 from a network.

The storage unit 40 is capable of storing an I/F application updater file 43, which is a file of an I/F application updater serving as an update application for updating the I/F application. The I/F application updater file 43 includes a new I/F application service file 43a for carrying out an update. However, the I/F application updater may be an application that acquires a new I/F application service file for carrying out an update from outside the image forming system 10. The I/F application updater file 43 may, for example, be additionally installed on the kiosk terminal 30 from a device that is external to the image forming system 10.

The storage unit 40 stores access destination information 44, which indicates the address of a destination accessed by an I/F application DLL 52a described below. The access destination information 44 may be stored in the RAM of the control unit 50 rather than being stored in the storage unit 40.

The control unit 50 includes, for example, a CPU, a ROM that stores programs and various data, and a RAM serving as the memory used as a work area of the CPU of the control unit 50. The CPU of the control unit 50 executes programs stored in the storage unit 40 or the ROM of the control unit 50.

The control unit 50 executes the function enhancement application file 41, the I/F application file 42, and the I/F application updater file 43 to realize the function enhancement application 51, the I/F application 52, and the I/F application updater 53, respectively. To describe the I/F application 52 in more detail, the control unit 50 executes the I/F application DLL file 42a and the I/F application service file 42b to realize the I/F application DLL 52a and the I/F application service 52b, respectively.

Next, the operation of the kiosk terminal 30 will be described.

First, the operation performed by the kiosk terminal 30 when the function enhancement application 51 is started will be described.

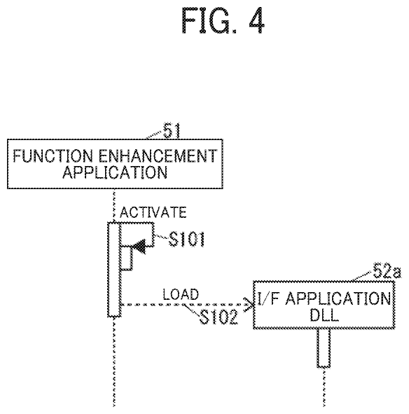

FIG. 4 is a sequence diagram of the operation performed by the kiosk terminal 30 when the function enhancement application 51 is started.

As shown in FIG. 4, the function enhancement application 51 is started when a specific condition is met, such as when an instruction to start the function enhancement application 51 is input via the operation unit 31 (S101).

When the function enhancement application 51 is started in S101, it loads the I/F application DLL 52a by reading the I/F application DLL file 42a (S102). The I/F application DLL file 42a becomes locked and can no longer be updated as a result of being read by the function enhancement application 51.

The I/F application service 52b is started when the kiosk terminal 30 is started.

Next, the operation performed by the kiosk terminal 30 when the I/F application DLL 52a receives an API (Application Program Interface) call from the function enhancement application 51 will be described.

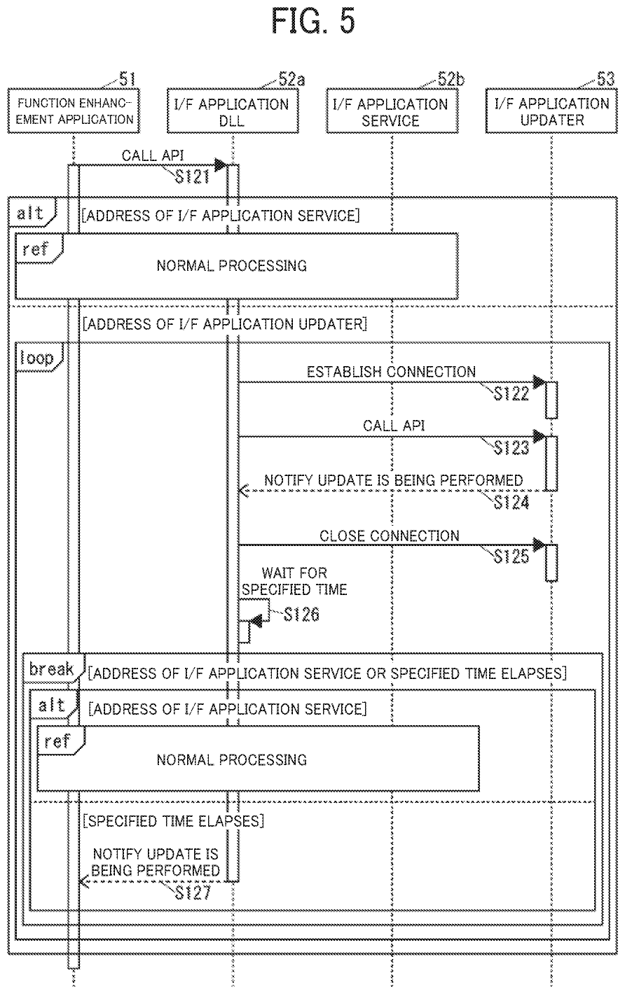

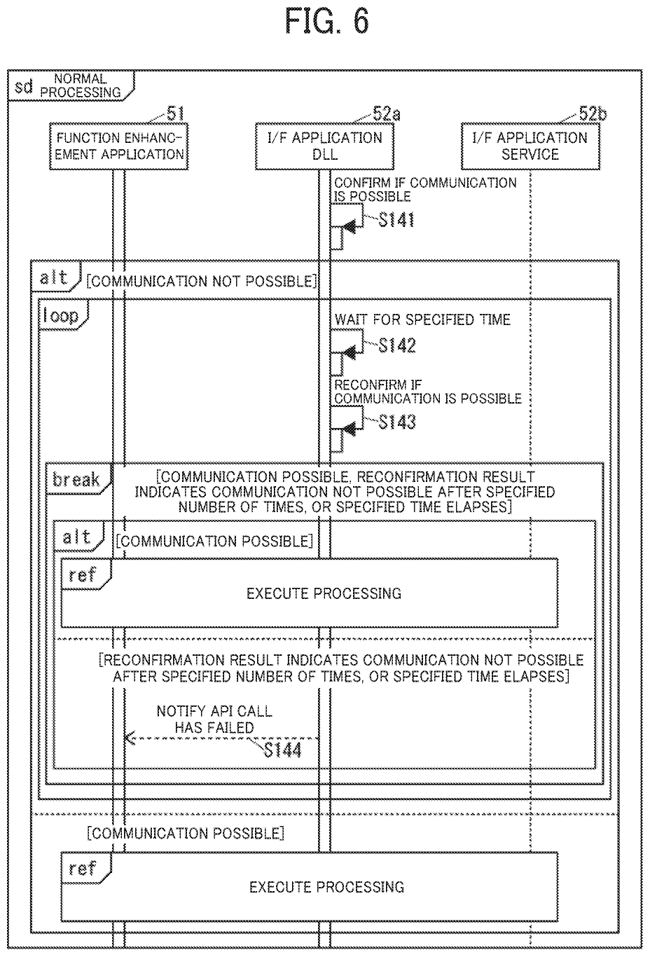

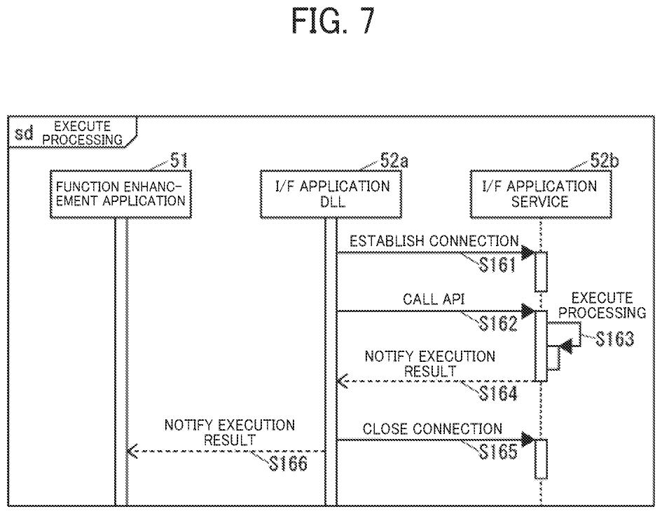

FIG. 5 is a sequence diagram of the operation performed by the kiosk terminal 30 when the I/F application DLL 52a receives an API call from the function enhancement application 51. FIG. 6 is a sequence diagram of the “normal processing” shown in FIG. 5. FIG. 7 is a sequence diagram of the “process execution” shown in FIG. 6.

As shown in FIG. 5 to FIG. 7, the function enhancement application 51 executes a specific API call with respect to the I/F application DLL 52a (S121).

When the I/F application DLL 52a receives the API call from the function enhancement application 51 in S121, if the destination indicated by the access destination information 44 is the address of the I/F application service 52b, it confirms whether or not communication is possible with the destination indicated by the access destination information 44, that is to say, the I/F application service 52b (S141).

If the confirmation result in S141 indicates that communication is not possible, the I/F application DLL 52a waits for a specified time (S142), and then reconfirms whether or not communication is possible with the I/F application service 52b (S143).

The I/F application DLL 52a repeats the processing of S142 and S143 until one of the following is satisfied: the reconfirmation result in S143 indicates that communication is possible; the reconfirmation result in S143 of whether or not communication is possible indicates that communication is not possible after a specified number of times; or a specified time has elapsed from the start of the processing of S141. Here, the specified number of times represents an upper limit value of the number of times the reconfirmation is performed, and is set in advance.

If the reconfirmation result in S143 of whether or not communication is possible indicates that communication is not possible after a specified number of times, or a specified time has elapsed from the start of the processing of S141, the I/F application DLL 52a notifies the function enhancement application 51 that the API call has failed (S144), and ends the operation shown in FIG. 5 to FIG. 7.

If the confirmation result in S141 indicates that communication is possible, or the reconfirmation result in S143 indicates that communication is possible, the I/F application DLL 52a establishes a connection with the I/F application service 52b (S161). Specifically, the I/F application DLL 52a opens a named pipe with the I/F application service 52b.

When the I/F application DLL 52a establishes the connection with the I/F application service 52b in S161, it executes a specific API call via the connection established in S161 (S162).

When the specific API is called from the I/F application DLL 52a in S162, the I/F application service 52b executes processing according to the call (S163).

Then, the I/F application service 52b notifies the I/F application DLL 52a of the execution result in S163 via the connection established in S161 (S164).

When the I/F application DLL 52a is notified of the execution result of the processing from the I/F application service 52b, it closes the connection established with the I/F application service 52b (S165).

Then, the I/F application DLL 52a notifies the function enhancement application 51 of the execution result notified by the I/F application service 52b in S164 (S166), and ends the operation shown in FIG. 5 to FIG. 7.

When the I/F application DLL 52a receives the API call from the function enhancement application 51 in S121, if the destination indicated by the access destination information 44 is the address of the I/F application updater 53, it establishes a connection with the I/F application updater 53 (S122). Specifically, the I/F application DLL 52a opens a named pipe with the I/F application updater 53.

When the I/F application DLL 52a establishes the connection with the I/F application updater 53 in S122, it executes an API call via the connection established in S122 (S123).

When the API is called from the I/F application DLL 52a in S123, the I/F application updater 53 notifies the I/F application DLL 52a via the connection established in S122 that the I/F application service 52b is being updated (S124).

When the I/F application DLL 52a is notified by the I/F application updater 53 in S124 that the I/F application service 52b is currently being updated, it closes the connection established with the I/F application updater 53 (S125).

Then, the I/F application DLL 52a waits for a specified time (S126).

The I/F application DLL 52a repeats the processing of S122 to S126 until the destination indicated by the access destination information 44 becomes the I/F application service 52b, or a specified time elapses from the start of the first processing of S122.

If the destination indicated by the access destination information 44 becomes the address of the I/F application service 52b, the I/F application DLL 52a executes the “normal processing” shown in FIG. 6.

If a specified time elapses from the start of the first processing of S122, the I/F application DLL 52a notifies the function enhancement application 51 that the I/F application service 52b is being updated (S127), and ends the operation shown in FIG. 5 to FIG. 7.

Next, the operation performed by the kiosk terminal 30 when the I/F application service 52b is updated will be described.

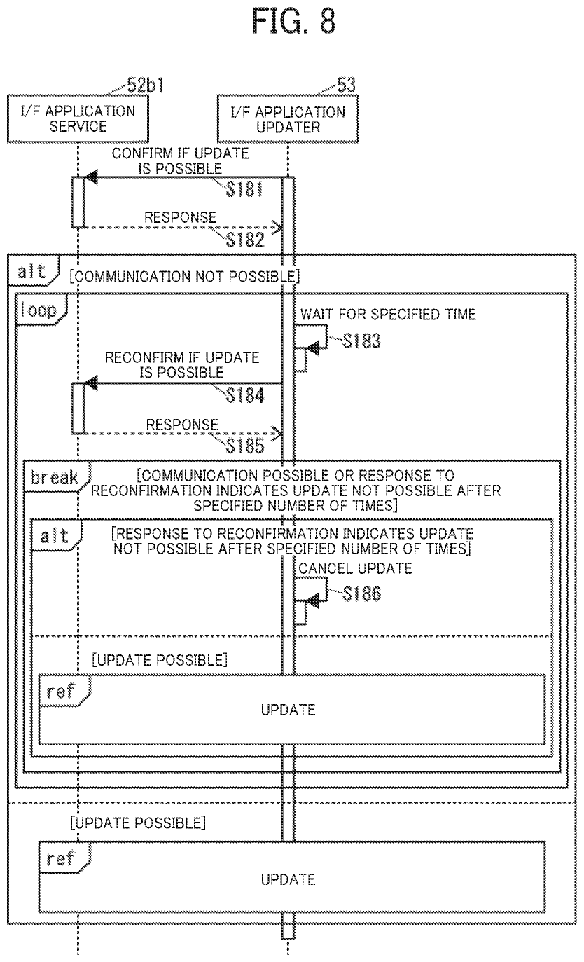

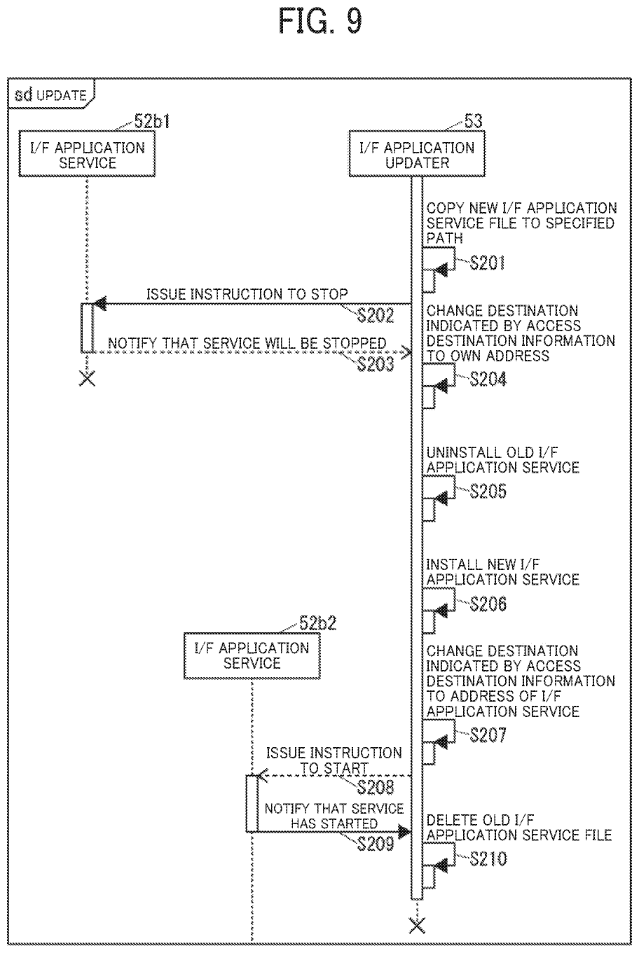

FIG. 8 is a sequence diagram of the operation performed by the kiosk terminal 30 when the I/F application service 52b is updated. FIG. 9 is a sequence diagram of the “update” shown in FIG. 8.

In the description of the operation shown in FIG. 8 and FIG. 9, the I/F application service 52b prior to being updated is represented by the I/F application service 52b1, and the I/F application service 52b after being updated is represented by the I/F application service 52b2. Similarly, the I/F application service file 42b prior being updated is represented by the OF application service file 42b1, and the OF application service file 42b after being updated is represented by the OF application service file 42b2.

A device that is external to the image forming system 10 distributes an OF application updater file to the kiosk terminal 30, for example, in response to an instruction from the user. When the OF application updater file is distributed, the control unit 50 of the kiosk terminal 30 stores the distributed OF application updater file in the storage unit 40 as the OF application updater file 43, and then executes the operation shown in FIG. 8 and FIG. 9.

As shown in FIG. 8 and FIG. 9, the OF application updater 53 confirms with the OF application service 52b1 whether or not it can be updated (S181).

When the OF application service 52b1 receives a request to confirm whether it can be updated from the OF application updater 53 in S181, it responds to the OF application updater 53 and indicates whether or not it can be updated (S182). Here, if the OF application service 52b1 has not established a connection with the OF application DLL 52a, it responds to the OF application updater 53 that it can be updated. On the other hand, if the OF application service 52b1 has established a connection with the OF application DLL 52a, it responds to the OF application updater 53 that it cannot be updated.

If the OF application updater 53 receives a response from the OF application service 52b1 in S182 indicating that it cannot be updated, it waits for a specified time (S183), and then reconfirms with the OF application service 52b1 whether or not it can be updated (S184).

When the OF application service 52b1 receives a request to confirm whether it can be updated from the OF application updater 53 in S184, it responds to the OF application updater 53 and indicates whether or not it can be updated in the same manner as the processing of S182 (S185).

The OF application updater 53 repeats the processing of S183 and S184 until one of the following is satisfied: the response from the OF application service 52b1 in S185 indicates it can be updated; or the reconfirmation of whether or not the OF application service 52b1 can be updated results in a response from the OF application service 52b1 in S185 indicating that it cannot be updated after a specified number of times. Here, the specified number of times is an upper limit value of the number of times the reconfirmation is performed, and is set in advance.

If the reconfirmation of whether or not the OF application service 52b1 can be updated results in a response from the OF application service 52b1 in S185 indicating that it cannot be updated after a specified number of times, the I/F application updater 53 cancels the update of the I/F application service 52b (S186).

If the response from the I/F application service 52b1 in S182 or S185 indicates that it can be updated, the I/F application updater 53 copies the I/F application service file 43a inside the I/F application updater file 43, that is to say, the I/F application service file 42b2 for the I/F application service 52b2 to a path other than the path in which the I/F application service file 42b1 for the I/F application service 52b1 is stored (S201).

Then, the I/F application updater 53 instructs the I/F application service 52b1 to stop (S202). When the I/F application service 52b1 stops as a result of the instruction from the I/F application updater 53, it issues a notification to that effect to the I/F application updater 53 (S203).

After the processing of S203, the I/F application updater 53 instructs the OS (Operating System) of the kiosk terminal 30 to change the destination indicated by the access destination information 44 to the address of the I/F application updater 53 itself so that processing requests from the I/F application DLL 52a are received by the I/F application updater 53 (S204). Consequently, the OS of the kiosk terminal 30 changes the destination indicated by the access destination information 44 to the address of the I/F application updater 53.

After the processing of S204, the I/F application updater 53 uninstalls the I/F application service 52b1 from the system of the kiosk terminal 30 (S205), and installs the I/F application service 52b2, whose I/F application service file 42b2 was stored in the storage unit 40 in S201, to the system of the kiosk terminal 30 (S206).

After the processing of S206, the I/F application updater 53 requests the OS of the kiosk terminal 30 to change the destination indicated by the access destination information 44 to the address of the I/F application service 52b2 so that processing requests from the I/F application DLL 52a are received by the I/F application service 52b2 rather than the I/F application updater 53 (S207). Therefore, the OS of the kiosk terminal 30 changes the destination indicated by the access destination information 44 to the address of the I/F application service 52b2.

After the processing of S207, the I/F application updater 53 instructs the I/F application service 52b2 installed in S206 to start (S208). When the I/F application service 52b2 starts as a result of the instruction from the I/F application updater 53, it issues a notification to that effect to the I/F application updater 53 (S209).

After the processing of S209, the I/F application updater 53 deletes the I/F application service file 42b1 for the I/F application service 52b1 from the storage unit 40 (S210).

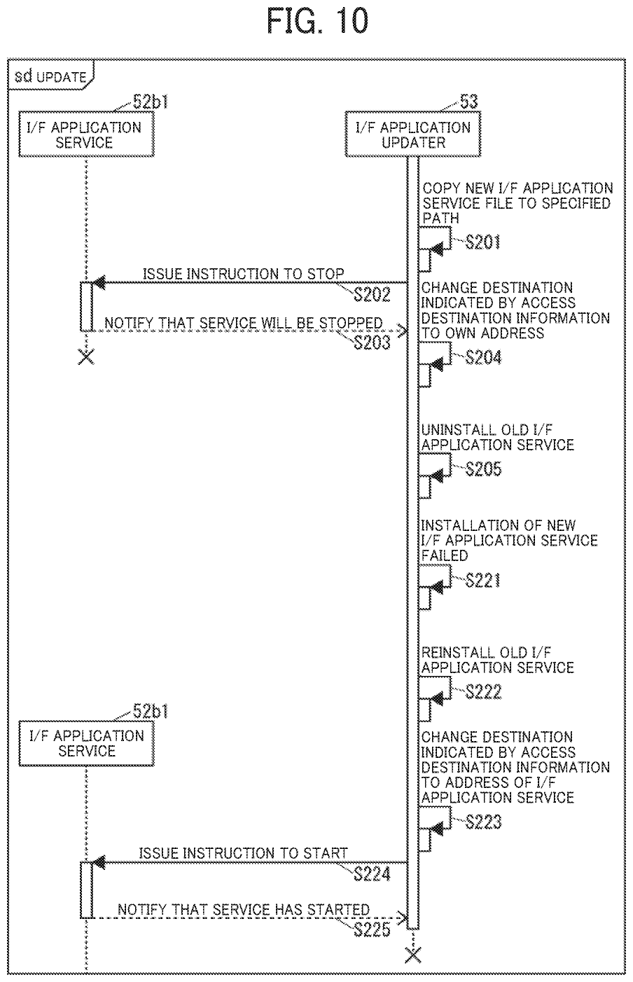

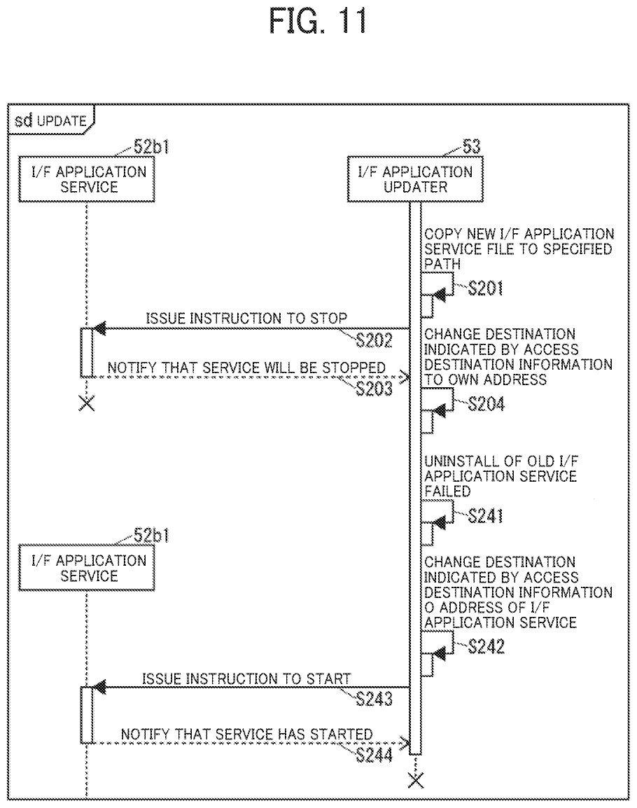

If the update of the I/F application service 52b fails, the I/F application updater 53 executes, for example, a rollback as shown in FIG. 10 or FIG. 11.

FIG. 10 is a sequence diagram of the operation performed by the kiosk terminal 30 when the I/F application service 52b is updated but installation of the new I/F application service 52b fails.

When the I/F application service 52b is updated but installation of the new I/F application service 52b fails, the kiosk terminal 30 executes the operation shown in FIG. 10 rather than the operation shown in FIG. 9.

As shown in FIG. 10, after the processing of S205, when the I/F application updater 53 fails to install the I/F application service 52b2, whose I/F application service file 42b2 was stored in the storage unit 40 in S201, on the system of the kiosk terminal 30 (S221), it reinstalls the I/F application service 52b1 on the system of the kiosk terminal 30 (S222).

After the processing of S222, the I/F application updater 53 requests the OS of the kiosk terminal 30 to change the destination indicated by the access destination information 44 to the address of the I/F application service 52b1 so that processing requests from the I/F application DLL 52a are received by the I/F application service 52b1 rather than the I/F application updater 53 (S223). Consequently, the OS of the kiosk terminal 30 changes the destination indicated by the access destination information 44 to the address of the I/F application service 52b1.

After the processing of S223, the I/F application updater 53 instructs the I/F application service 52b1 installed in S222 to start (S224). When the I/F application service 52b1 starts as a result of the instruction from the I/F application updater 53, it issues a notification to that effect to the I/F application updater 53 (S225).

FIG. 11 is a sequence diagram of the operation performed by the kiosk terminal 30 when the I/F application service 52b is updated but uninstallation of the old I/F application service 52b fails.

When the I/F application service 52b is updated but uninstallation of the old I/F application service 52b fails, the kiosk terminal 30 executes the operation shown in FIG. 11 rather than the operation shown in FIG. 9.

As shown in FIG. 11, after the processing of S204, when the I/F application updater 53 fails to uninstall the I/F application service 52b1 from the system of the kiosk terminal 30 (S241), it requests the OS of the kiosk terminal 30 to change the destination indicated by the access destination information 44 to the address of the I/F application service 52b1 so that processing requests from the I/F application DLL 52a are received by the I/F application service 52b1 rather than the I/F application updater 53 (S242). Therefore, the OS of the kiosk terminal 30 changes the destination indicated by the access destination information 44 to the address of the I/F application service 52b1.

After the processing of S242, the I/F application updater 53 instructs the I/F application service 52b1 to start (S243). When the I/F application service 52b1 starts as a result of the instruction from the I/F application updater 53, it issues a notification to that effect to the I/F application updater 53 (S244).

As described above, in the kiosk terminal 30, the function enhancement application 51 reads the I/F application DLL 52a rather than the I/F application service 52b of the I/F application 52 (S102), and the I/F application updater 53 updates the I/F application service 52b rather than the I/F application DLL 52a, which becomes locked and can no longer be updated as a result of being read by the function enhancement application 51 (S205 and S206). Therefore, among the function enhancement application 51 and the I/F application 52, which are cooperating with each other, the I/F application 52 can be updated without stopping the function enhancement application 51.

In the kiosk terminal 30, if a call is made from the function enhancement application 51 to the I/F application 52 (S121) while the I/F application service 52b is being updated by the I/F application updater 53 (S205 and S206), the kiosk terminal 30 waits until the update of the I/F application service 52b is completed (S122 to S126). Then, the processing corresponding to the call of the I/F application 52 from the function enhancement application 51 is executed by the I/F application service 52b (S163), and the I/F application DLL 52a notifies the function enhancement application 51 of the execution result (S166). Therefore, when a call is made from the function enhancement application 51 to the I/F application 52, a common algorithm can be used for the operation of the function enhancement application 51 irrespective of whether or not the I/F application service 52b is being updated by the I/F application updater 53.

In the kiosk terminal 30, if a call is made from the function enhancement application 51 to the I/F application 52 (S121) while the I/F application service 52b is being updated by the I/F application updater 53 (S205 and S206), and the update of the I/F application service 52b by the I/F application updater 53 fails (S221), the I/F application updater 53 performs a rollback of the I/F application service 52b to a state of the I/F application service 52b prior to the update operation (S222). Then, the processing corresponding to the call of the I/F application 52 from the function enhancement application 51 is executed by the I/F application service 52b (S163), and the OF application DLL 52a notifies the function enhancement application 51 of the execution result (S166). Therefore, a common algorithm can be used for the operation of the function enhancement application 51 irrespective of whether or not the update of the OF application service 52b by the OF application updater 53 has failed.

What is claimed is:

1. An information processing system including:
a first application and a second application that cooperate with each other; and
an update application for updating the second application; wherein
the second application includes
a main body portion that, in a case where a call is made from the first application to the second application, executes processing according to the call, and
an interface portion that notifies the first application of an execution result of the processing,
the first application reads the interface portion rather than the main body portion, and
the update application updates the main body portion.

2. The information processing system according to claim 1, wherein
the main body portion, in a case where the call is made while being updated by the update application, executes the processing after an update has been performed by the update application.

3. The information processing system according to claim 1, wherein
the update application, in a case where an update of the main body portion has failed, performs a rollback of the main body portion to a state of the main body portion prior to an update operation, and
the main body portion, in a case where the call is made while being updated by the update application, and an update by the update application fails, executes the processing after a rollback is performed by the update application.
